(19) United States
(12) Patent Application Publication
(10) Pub. No.: US 2017/0161506 A1
(43) Pub. Date: Jun. 8, 2017

(54) Information Handling System Encrypted Image Display Through Secondary Device

(71) Applicant: Dell Products L.P., Round Rock, TX (US)

(72) Inventors: Carrie E. Gates, Livermore, CA (US); Christopher D. Burchett, Lewisville, TX (US); David Konetski, Austin, TX (US)

(73) Assignee: Dell Products L.P., Round Rock, TX (US)

(21) Appl. No.: 14/960,809

(22) Filed: Dec. 7, 2015

(51) Int. Cl. G06F 21/60; G09G 5/00; G06F 21/62; G06F 3/14; G06F 21/32; H04L 9/08

(52) U.S. Cl. CPC G06F 21/602; G06F 21/32; H04L 9/0819; G06F 21/6245; G06F 3/1423; G09G 5/006; G09G 2358/00; G09G 2370/16

(57) ABSTRACT

A wearable display presents information to an end user as visual images having restricted access to other viewers, such as at an eyeglass worn by the end user. Sensitive information that an end user selects for viewing is precluded from presentation at a primary information handling system display and is instead presented at the wearable display, such as with an overlay of the primary display that has the sensitive information presented by the wearable display over the location of the primary display at which the sensitive information would otherwise be presented.

### BACKGROUND OF THE INVENTION

Field of the Invention

The present invention relates in general to the field of information handling system image presentation, and more particularly to an information handling system encrypted image display through secondary device.

Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems have become ubiquitous as both a professional and personal resource. Smart phone information handling systems, for example, provide end users with essentially full access to network-accessible information at remote locations interfaced through wireless wide area networks (WWANs) and/or wireless local area networks (WLANs), such as hot spots located in coffee shops, airport terminals, etc. Other types of portable information handling systems that have greater processing power and more user-friendly input/output devices, such as tablets and laptops, provide processing platforms that let users create and edit documents at remote and public locations. Accessing information of a sensitive nature at remote locations through network interfaces presents a security risk that is typically addressed by encrypting the information during transit. For instance, sensitive information is typically accessed with a virtual private network (VPN) or secure FTP interface. Often enterprises will impose additional security steps so that sensitive information will not be exposed if the information handling system is lost or stolen. Such security steps may include password protection to gain access to a device, password protection to gain access to enterprise applications, and encryption at an information handling system storage device. As example of a common security step, information handling systems will often transition to a password protected screen saver after non-use for a defined time. In some instances, information handling systems actively monitor their context and enforce security measures if a threat is detected.

Ultimately, in order to use information an end user typically has to view the information at a display device in an unencrypted presentation. In crowded public spaces, such as airports, train terminals, coffee shops, or restaurants, knowledge workers wishing to work on sensitive information have no consistently secure way of viewing and editing documents or other information in public without risking disclosure of the sensitive information to casual observation by anyone passing by who glances at the display. A variety of display protections are available to limit access at a display when unauthorized users attempt to view a display, however, these protective steps are generally inconvenient and often ineffective. For example, screen privacy filters attached over a display help reduce viewing angles from which the display may be seen, but tend to make viewing more difficult and less comfortable for authorized viewers. Automated lock down of display content from unauthorized viewers relies upon accurate detection of unauthorized viewing and creates inconvenience for an end user if activated in an untimely manner. Further, in some cases a user may want to share displayed content with another authorized user so that automated protection of displayed content can prove inconvenient and even embarrassing.

### SUMMARY OF THE INVENTION

Therefore, a need has arisen for a system and method which provides an information handling system display of sensitive information with reduced risk of unauthorized observation.

In accordance with the present invention, a system and method are provided which substantially reduce the disadvantages and problems associated with previous methods and systems for presenting sensitive visual information at a display in a public area. Sensitive information presentation is withheld at a primary display, such as by precluding, hiding or encrypting the sensitive information, and instead presented at a wearable display that presents less risk of unauthorized observation, such as a wearable eyeglasses display.

More specifically, a portable information handling system includes a processor, memory and display that cooperate to present information as visual images. Portions of the visual images that include sensitive information are withheld from presentation in public locations, such as by leaving the portion of the portable information handling system display that includes the sensitive information blank or encrypted in order to protect the information from observation by unauthorized individuals who have a view of the display. A security module of the portable information handling system passes the sensitive information to a wearable display device authorized by the user of the information handling system to present sensitive information, such as eyeglasses having a wearable view display. The sensitive information may be presented as an overlay to the location on the information handling system display that is withheld or in an independent location. The sensitive information may be provided to the wearable display device by an encrypted or unencrypted wireless communication in either a content format that the wearable display renders or as pixel values generated at the portable information handling system.

The present invention provides a number of important technical advantages. One example of an important technical advantage is that sensitive information is protected from unauthorized observation at a primary display device by withholding presentation from the primary display device and presenting the sensitive information at a secondary display device with less risk of observation, such as wearable glasses with a wearable view display. In one example embodiment of wearable glasses, the sensitive information is presented at the eyeglass display lined up as an overlay to the presentation position on the primary display so that an end user can interact with the primary information handling system as if it were presenting the data. For example, an end user typing a reply to a sensitive information sees at the wearable display the reply content while other observers of the primary display see only a blank box where the email is presented. The wearable display acts as a secondary display for presentation of a window that the wearable display aligns with identifying markings of the primary display, such as with a blue screen effect.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a portable information handling system having sensitive display information withheld from presentation at a primary display and instead presented to an end user at a wearable view display;

FIG. 2 depicts a block diagram of a system for selectively presenting sensitive information at a wearable display; and

FIG. 3 depicts a flow diagram of a process for selective presentation of sensitive information at a primary or secondary display device.

### DETAILED DESCRIPTION

A wearable information handling system selectively presents sensitive visual information withheld at a primary information handling system display to restrict the sensitive information from observation by unauthorized viewing. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (PO) devices, such as a keyboard, a mouse, and a video display. The information handling system may also include one or more buses operable to transmit communications between the various hardware components.

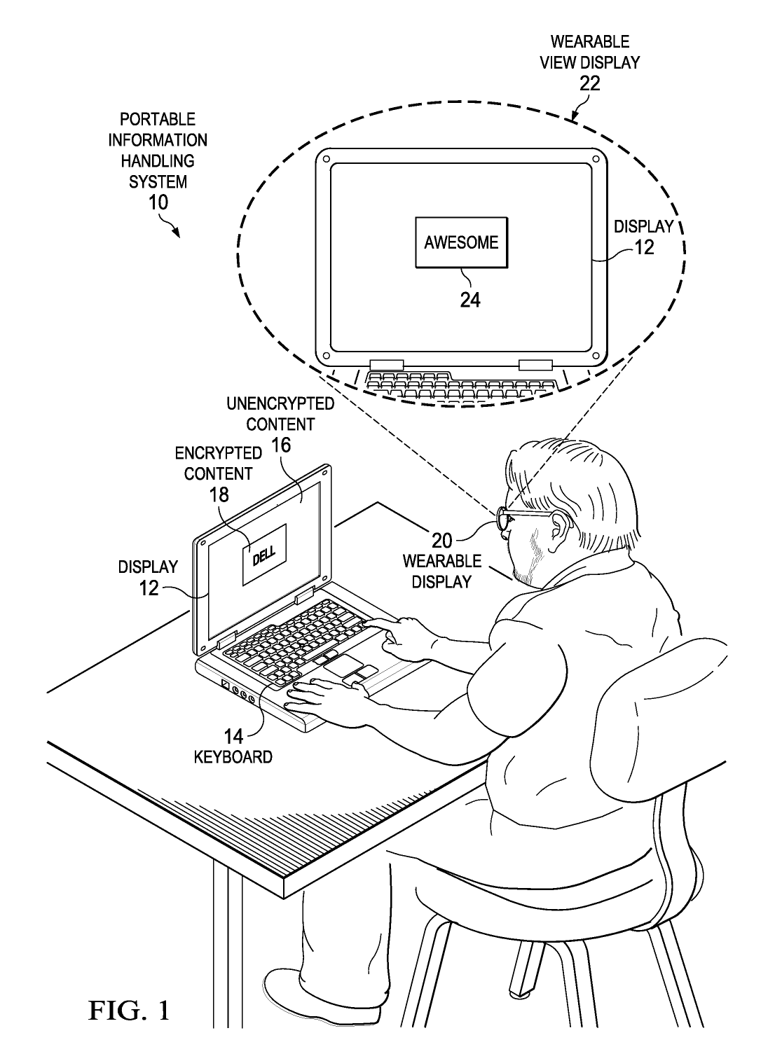

Referring now to FIG. 1, a portable information handling system 10 is depicted having sensitive display information 18 withheld from presentation at a primary display 12 and instead presented to an end user at a wearable view display 22. Portable information handling system 10 in the example embodiment has a clamshell laptop configuration with display 12 integrated in a lid housing portion and a keyboard 14 integrated in a main housing portion. End users tend to prefer to use portable information handling systems that have integrated keyboards 14 when performing tasks on the go that involve typed inputs. Display 16 presents content generated by portable information handling system 10 in a raised position relative to keyboard 14 by rotating the housing portions relative to each other. End users thus have a convenient keyboard and display stand integrated in a single housing so that content 16 at display 12 is readily viewable while the end makes inputs to keyboard 14. However, while the end user can readily view content presented by display 12, so can other unauthorized individuals in the area. Thus, to prevent sensitive information from casual viewing by unauthorized individuals, sensitive information is presented as encrypted content 18 or otherwise indicated as withheld from unprotected presentation vulnerable to viewing. Although the example embodiment depicts a portable information handling system 10 having a laptop configuration, in alternative embodiments other types of configurations may be used, such as tablet information handling systems or desktop information handling systems that present visual information as visual images at a peripheral display.

In order to provide the end user with convenient viewing of sensitive information withheld from presentation at display 12, such as encrypted information 18 presented in encrypted form, a wearable display 20 is worn by the end user, such as eyeglasses that have a wearable view display 22 to present visual information as visual images. Within wearable view display 22 the end user views portable information handling system 10 having encrypted content 18 overlaid with visual information generated at wearable display 20 that presents decrypted content 24. Thus, the end user is able to view display 12 as if all of the content presented at display 12 is unencrypted because wearable display 20 presents encrypted content 18 at wearable view display 22 in unencrypted form. Although the example embodiment depicts encrypted content 18, in alternative embodiments sensitive content may be handled in alternative manners. For example, sensitive content may be presented as a blank box or window having a “blue screen” or other similar identifying feature that directs wearable display 20 where to present the sensitive information. Alternatively, sensitive information is simply withheld from display 12 and presented at wearable display 20 in a manner selected by the end user. In other alternative embodiments, sensitive information is withheld or obscured from view in other ways so that unauthorized individuals who can view display 12 cannot view the sensitive information. Further, in alternative embodiments, sensitive information may be viewed by devices other than a wearable display device, such as by presenting the sensitive information at a tablet or smartphone information handling system, or another portable information handling system that reminds the user to keep certain sensitive information from inadvertent viewing by unauthorized observers. In various example embodiments, the secondary display that presents sensitive information may include any type of smart display device that has communication and processing resources to receive sensitive information from a primary system, including smart televisions or other non-portable devices that a user may have available.

As an example of a use case, an end user opens a word processing document at portable information handling system 10 having a security plugin that encrypts created content when presented at display 12. For example, the security plugin encrypts, tokenizes or otherwise transforms the content so that the content is renderable by the word processor but the content is not human readable at display 12. The end user puts on wearable display 20 having a wearable view display 22 in glasses that include biometric user authentication, such as iris scan. Wearable display 20 authenticates the user and establishes a secure wireless connection with portable information handling system 10, such as through Bluetooth, WiFi or a wireless display interface that sends pixel data. A security application running on wearable display device 20 receives content typed into portable information handling system 10 for presentation in unencrypted form at wearable view display 22 so that the end user sees typed content as if presented at display 12. Various security techniques may be applied to protect the information transmitted over the wireless communications link, and to determine if the information should be transmitted to the secondary device, including using a session key to encrypt the information and using location proximity and user authentication to determine if the information should be transmitted. Alternatively, the information may be sent wirelessly or through a wired connection without encryption where the primary security concern is the unauthorized observation of displayed content and not signal snooping.

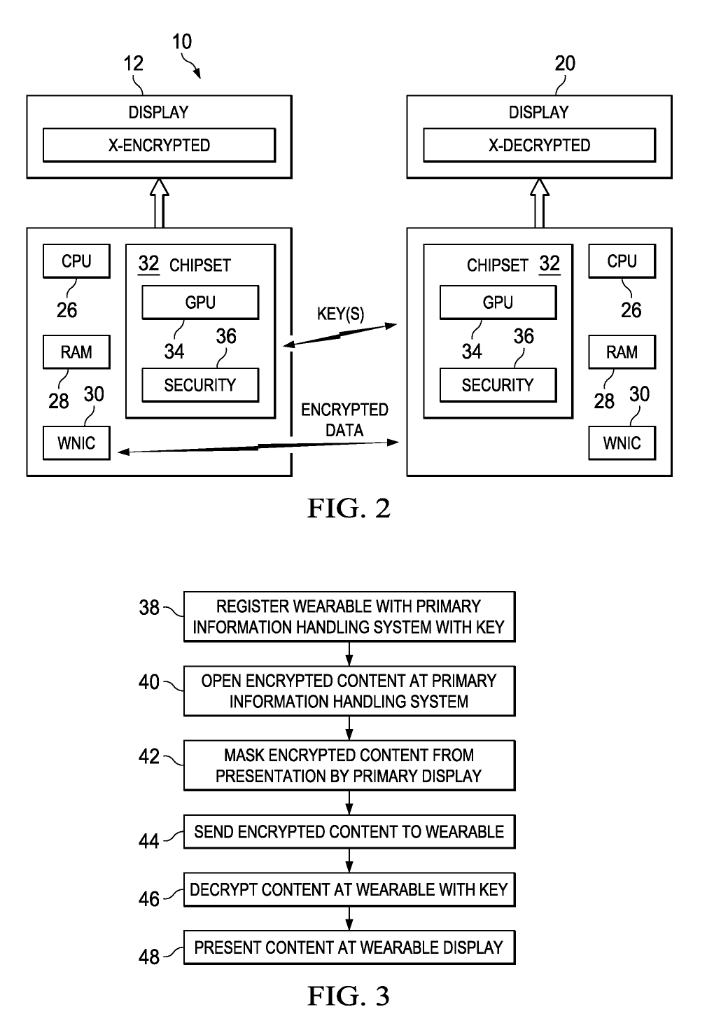

Referring now to FIG. 2, a block diagram of a system for selectively presenting sensitive information at a wearable display. Portable information handling system 10 has a central processing unit (CPU) 26 that executes instructions, random access memory (RAM) 28 that stores instructions and information and a wireless network interface card (WNIC) 30 that communicates with wireless signals, such as wireless personal area network (WPAN) and wireless local area network (WLAN) signals. A chipset 32 includes various processing components and firmware components that coordinate execution of instructions and processing of information. For example, a graphics processing unit (GPU) 34 processes information into pixel values that generate visual images at display 12. A security module 36 is, for example, a hardware, firmware or software unit with trusted encryption and decryption capabilities that manages information security. For example, an enterprise provides settings at security module 36 that prohibits presentation of enterprise information at display 12 unless an enterprise location is detected by a wireless signal, such as WLAN or GPS location. Thus, for instance, if an end user is in an airport, the end user's enterprise email or documents will not present in a human readable form at display 12. Instead, the enterprise information may be presented in encrypted form, may be completely withheld from presentation or may be withheld from presentation with an identifying feature, such as window or display area presented with a blue screen or other marker.

Wearable display device 20 is an information handling system similar to portable system 10 but built with smaller components to fit over the end user's eye in an eyeglasses configuration. Security module 36 forms the opposing end of the security environment by accepting encrypted information and presenting the encrypted information in decrypted form at wearable view display 22. The manner of transfer of information and the manner of presentation may vary based on the available wireless bandwidth, the type of information and user preferences. For example, with a wideband wireless interface, such as a 60 GHz interface, wearable display 20 acts as a second display of portable information handling system by accepting pixel values through the wireless interface. With a more narrow bandwidth, such as a Bluetooth interface, portable information handling system sends content as text, such as typed inputs. If no secure wireless signal is available, encrypted text presented at display 12 and captured with a camera of wearable display 20 is determined from the captured image with optical code reading and decrypted for presentation by wearable view display 22. In any of the examples, wearable display 20 may present content as an overlay of portable information handling system 10 such that the user views content in the same place that the user would view the content at portable information handling system 10 directly in a secure area. For example, portable information handling system 10 presents a blue screen or other identifier that a camera of wearable display 20 captures so that wearable display 20 superimposes the decrypted information at the position where it would have been presented on display 12.

In one embodiment, Internet of Thing (IOT) gateways may enhance wearable display 20 presentation of information, such as where IOT gateways are disposed in a location like the mechanical access of a smart building. For example, a wearable or other portable display receives encrypted information from IOT gateways and present the information in decrypted form without having a line of sight interface to the IOT gateway, such as through a building wall. In an example embodiment, using GPS location, WiFi and/or Bluetooth proximity, technicians can access service infrastructure of a building to locate, assess and even repair IOT gateways without direct physical access. Security benefits of this approach include obviating the need for access to sensitive building infrastructure and an inherent additional factor of authentication that prevents even physical access to IOT gateways from having access to sensitive information managed by the IOT gateways since the sensitive information is not read locally without the secondary display system having the provisioned split key.

Referring now to FIG. 3, a flow diagram of a process for selective presentation of sensitive information at a primary or secondary display device. The process begins at step 38 with registration of a wearable information handling system have a secure display to a primary information handling system having a vulnerable display, such as open to observation by unauthorized end users. At step 40 an end user opens sensitive content at the primary information handling system, such as encrypted information or information that is otherwise identified as sensitive. At step 42, the primary information handling system masks or otherwise withholds sensitive information from presentation at the primary information handling system display. The mask may include a presentation of ciphertext, a blank area, a picture or animated gif or other indication that information is withheld from presentation. Information may be redacted at the primary display, such as with portions blacked out and portions presented as normal content, may be presented with an entire document encrypted or may be withheld entirely from presentation unless a wearable device Bluetooth beacon or GPS position is within a defined range.

At step 44, encrypted information withheld from presentation at the primary display is sent as encrypted content to the wearable display. In one example embodiment, the wearable device detects that information is withheld from presentation by analyzing a captured image of the primary display so that the wearable device initiates transfer of sensitive information only when the primary information handling system is in viewing distance. The user is authenticated using biometric data, and the sensitive information is encrypted using a session key and restricted from transfer except to wearable devices registered to the end user at the primary information handling system, such as might be determined from the Bluetooth unique identifier. In alternative embodiments, other indications may be tracked by the wearable device to ensure that an end user remains within a defined distance of the primary information handling system, otherwise transfer of sensitive data is stopped, such as distance defined by Bluetooth proximity or GPS location. At step 46, the sensitive information is decrypted by the wearable information handling system and at step 48 presented at the wearable display in unencrypted form. Although described herein in terms of a wearable eyeglasses information handling system having hardware and firmware security modules, in alternative embodiments, a software only solution may be used to allow an end user to share sensitive information with other end users having wearable display devices, such as to collaborate with authorized users focused on the primary display in an insecure area without presenting secure information at the primary display.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
a processor disposed in the housing and operable to execute instructions to process information;
a memory disposed in the housing and interfaced with the processor, the memory operable to store the information;
a display disposed in the housing and interfaced with the processor and memory, the display operable to present the information as visual images;
a wireless network interface device interfaced with the processor and operable to communicate
a security module interfaced with the processor and operable to encrypt at least part of the information presented as visual images at the display, the encrypted information protected from presentation at the display in unencrypted form; and
a wearable secondary display interfaced with the security module through the wireless network interface device and operable to decrypt the information and present the information in decrypted form as visual images.

2. The information handling system of claim 1 wherein the security module provides pixel values of the encrypted information to the wearable secondary display and the wearable secondary display decrypts the pixel values to present the encrypted information as unencrypted visual images.

3. The information handling system of claim 1 wherein the security module provides content values of the encrypted information to the wearable secondary display and the wearable secondary display decrypts the content values to generate pixel values for presentation of a visual image having the encrypted information in unencrypted form.

4. The information handling system of claim 1 wherein the security module presents location information at the display in the place of the encrypted information and the wearable secondary display presents the information in decrypted form to overlap the location information.

5. The information handling system of claim 4 wherein the location information comprises a content box having a blank area.

6. The information handling system of claim 1 wherein the wearable secondary display comprises eyeglasses worn by a user.

7. The information handling system of claim 1 wherein the security module presents the encrypted information at the display in encrypted form, the wearable display captures the encrypted information in encrypted form as an image, decrypts the information and presents the information in decrypted form as an overlay over the encrypted form image.

8. The information handling system of claim 1 wherein the wearable display authenticates the user with the security module using biometric information so that the security module releases a key to the secondary display to decrypt the information.

9. A method for presenting visual information at an information handling system, the method comprising:
selecting the visual information for presentation at a primary display;
identifying at least some of the visual information as sensitive information;
precluding the sensitive information from presentation at the primary display in an unencrypted form;
communicating the sensitive information to a secondary display; and
presenting the sensitive information at the secondary display in unencrypted form.

10. The method of claim 9 further comprising:
identifying at least some of the visual information as non-sensitive information; and
presenting the non-sensitive information at the primary display in unencrypted form.

11. The method of claim 10 further comprising:
marking a portion of the primary display with the non-sensitive information to define a location for presentation of the sensitive information; and
presenting the sensitive information in unencrypted form at the location with the secondary display as an overlay to the primary display.

12. The method of claim 11 wherein the secondary display comprises a portable information handling system having a processor disposed in a portable housing and configured to decrypt sensitive information to present the sensitive information at the secondary display.

13. The method of claim 12 wherein the secondary display comprises a portable information handling system configured as a smartphone.

14. The method of claim 9 wherein communicating the sensitive information to the secondary display comprise sending pixel values to the secondary display from an information handling system driving the primary display.

15. The method of claim 14 wherein the pixel values are encrypted during the sending.

16. The method of claim 9 wherein communicating the sensitive information to the secondary display comprises sending sensitive information content from the primary information handling system to the secondary display and generating pixel values to present the sensitive information at the secondary display.

17. The method of claim 9 wherein communicating the sensitive information further comprises:
presenting the sensitive information in encrypted form at the primary display;
capturing an image of the primary display with the secondary display; and
decrypting the sensitive information with the secondary display from the captured image.

18. A wearable information handling system comprising:
a processor operable to process information;
a wearable view display interfaced with the processor and operable to present information as visual images;
a wireless network interface device operable to communicate information has wireless signals; and
a security module interfaced with the processor and operable to decrypt information presented in encrypted form at a primary display and to present the information at the wearable view display in unencrypted form.

19. The wearable information handling system of claim 18 wherein the security module is further operable to present the information as an overlay to the primary display.

20. The wearable information handling system of claim 19 wherein overlay presents the information as an overlay located over the presentation of the information in encrypted form by the primary display.

21. The wearable information handling system of claim 18 wherein the security module receives the information as unencrypted pixel values sent through a wired interface.
